(19) United States
(12) Patent Application Publication
(10) Pub. No.: US 2026/0268503 A1
(43) Pub. Date: Sep. 10, 2026

(54) 3D SPACE MAPPING DEVICE AND SYSTEM FOR TRACKING AND RE-IDENTIFYING 3D OBJECT BASED ON MEMORY AND OPERATING METHOD OF THE SAME

(71) Applicant: ELECTRONICS AND TELECOMMUNICATIONS RESEARCH INSTITUTE, Daejeon (KR)

(72) Inventors: Sanghun JEON, Daejeon (KR); Minhyuk KIM, Daejeon (KR); Yong-Ju Lee, Daejeon (KR)

(21) Appl. No.: 19/547,899

(22) Filed: Feb. 24, 2026

(30) Foreign Application Priority Data
Mar. 4, 2025 (KR) 10-2025-0027488
Jan. 5, 2026 (KR) 10-2026-0000961

(51) Int. Cl. G06T 7/20; G06T 7/50; G06T 19/20

(52) U.S. Cl. CPC G06T 7/20; G06T 7/50; G06T 19/20; G06T 2207/10028

(57) ABSTRACT

Provided is a three-dimensional (3D) space mapping device for tracking and reidentifying a 3D object on the basis of memory, the 3D space mapping device including a semantic memory, an episodic memory, and a graphics processing unit (GPU) connected to the semantic memory and the episodic memory. The GPU detects an object by combining pairs of red-green-blue (RGB) and depth images input in chronological order, stores object representation information of the detected object in the semantic memory, moves the object representation information stored in the semantic memory to the episodic memory in the chronological order, and compares and analyzes past object information and current object information read from the episodic memory to analyze a movement path and a location change of the object. The object representation information includes at least one of visual information, semantic information, and spatial information.

### CROSS-REFERENCE TO RELATED APPLICATIONS

This application claims priority under 35 U.S.C. §119 to Korean Patent Application Nos. 10-2025-0027488, filed on Mar. 4, 2025, and 10-2026-0000961, Jan. 5, 2026, the disclosure of which is incorporated herein by reference in its entirety.

### BACKGROUND

### 1. Field of the Invention

Various exemplary embodiments disclosed in the present document relate to a three-dimensional (3D) object tracking and 3D space mapping technology, and more particularly, to a device for effectively searching for objects included in red-green-blue (RGB) images by fusing visual features and text information of the objects, storing found objects in a semantic memory and an episodic memory, and continuously tracking and re-recognizing the objects, an operating method of the device, and a system including the device.

### 2. Description of Related Art

With recent advancements in computer vision and artificial intelligence (AI) technology, research into object detection, segmentation, and mapping techniques in three-dimensional (3D) space is actively underway.

Particularly, fields such as robot vision, augmented reality (AR), autonomous driving, smart manufacturing, intelligent surveillance system, etc., require a technology for accurately identifying the locations of objects and mapping their positions in 3D space.

Existing object detection and mapping technologies primarily rely on object recognition using a red-green-blue (RGB)-depth (D) sensor for simultaneously capturing RGB images and depth information or simultaneous localization and mapping (SLAM) utilizing 3D point clouds.

Also, convolutional neural network (CNN)-based object detection models such as a you only look once (YOLO) model and a faster region-based convolutional neural network (R-CNN) model, and segmentation models such as a mask R-CNN model, are utilized in image-based object search, and for 3D mapping, techniques such as voxel-based mapping, OctoMap, neural radiance fields (NeRF), etc., are employed.

Most existing object detection technologies are limited to 2D image-based detection, resulting in limitations in providing accurate 3D location information of objects. This leads to difficulties in accurately inferring positions when a robot manipulates an object or redetects an object in a specific environment.

General 3D mapping technologies primarily represent spatial geometries as voxels or point clouds, but many of them do not have a precise detection function for individual objects. On the other hand, object detection technologies focus on detecting objects within 2D images, which leads to the problem that object detection and spatial mapping are not organically connected.

Existing object detection technologies can only detect predefined classes (labels), and their function of detecting new objects in new environments or specify objects on the basis of natural language is limited. Therefore, it is difficult to perform flexible object detection and re-recognition in real life.

### SUMMARY OF THE INVENTION

Various embodiments disclosed in the present document provide a device for effectively searching for objects included in red-green-blue (RGB) images by fusing visual features and text information of the objects, storing found objects in a semantic memory and an episodic memory, and continuously tracking and re-recognizing the objects, an operating method of the device, and a system including the device.

According to an embodiment disclosed in the present document, there is provided a three-dimensional (3D) space mapping device for tracking and reidentifying a 3D object on the basis of memory, the 3D space mapping device including a semantic memory, an episodic memory, and a graphics processing unit (GPU) connected to the semantic memory and the episodic memory. The GPU detects an object by combining pairs of RGB and depth images which are input in chronological order, stores object representation information of the detected object in the semantic memory, moves the object representation information stored in the semantic memory to the episodic memory in the chronological order, and compares and analyzes past object information and current object information read from the episodic memory to analyze a movement path and a location change of the object. The object representation information includes at least one of visual information, semantic information, and spatial information, the past object information is information related to a first RGB image and a first depth image of a first time point, and the current object information is information related to a second RGB image and a second depth image of a second time point.

According to an embodiment disclosed in the present document, there is provided a 3D space mapping system for tracking and reidentifying a 3D object on the basis of memory including an input device and a 3D space mapping device for tracking and re-identifying a 3D object on the basis of memory, connected to the input device. The 3D space mapping device includes an input interface configured to receive pairs of RGB image and depth images which are input in chronological order, a semantic memory, an episodic memory, and a GPU connected to the semantic memory, the episodic memory, and the input interface. The GPU detects an object by combining pairs of RGB and depth images received through the input interface in chronological order, stores object representation information of the detected object in the semantic memory, moves the object representation information stored in the semantic memory to the episodic memory in the chronological order, and compares and analyzes past object information and current object information read from the episodic memory to analyze a movement path and a location change of the object. The object representation information includes at least one of visual information, semantic information, and spatial information, the past object information is information related to a first RGB image and a first depth image of a first time point, and the current object information is information related to a second RGB image and a second depth image of a second time point.

The GPU may generate a 3D voxel map on the basis of the past object information, re-localize the 3D voxel map on the basis of the current object information, and update the 3D voxel map with the re-localized 3D voxel map.

The GPU may re-search for the object included in the past object information on the basis of the past object information and the current object information stored in at least one of the semantic memory and the episodic memory.

When object information of a new object is included in the current object information, the GPU may combine a visual change and a spatial change of the new object with the past object information using the semantic memory to expand the current object information.

According to another embodiment disclosed in the present document, there is provided an operating method of a 3D space mapping device for tracking and reidentifying a 3D object on the basis of memory, the operating method including detecting an object by combining pairs of RGB and depth images which are input in chronological order, storing object representation information of the detected object in a semantic memory and then moving the object representation information stored in the semantic memory to an episodic memory in the chronological order, and comparing and analyzing past object information and current object information read from the episodic memory to analyze a movement path and a location change of the object. The object representation information includes at least one of visual information, semantic information, and spatial information, the past object information is information related to a first RGB image and a first depth image of a first time point, and the current object information is information related to a second RGB image and a second depth image of a second time point.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a block diagram of a three-dimensional (3D) space mapping system for tracking and reidentifying a 3D object on the basis of memory according to an embodiment of the present document;

FIG. 2 is a set of red-green-blue (RGB) images input in chronological order;

FIG. 3 is a block diagram of a 3D space mapping module included in the 3D space mapping system for tracking and reidentifying a 3D object on the basis of memory shown in FIG. 1;

FIG. 4 is a block diagram of an object detection module included in the 3D space mapping system for tracking and reidentifying a 3D object on the basis of memory shown in FIG. 1;

FIG. 5 is a block diagram of an object segmentation module included in the 3D space mapping system for tracking and reidentifying a 3D object on the basis of memory shown in FIG. 1; and

FIG. 6 is a block diagram of an object data storage and re-search module included in the 3D space mapping system for tracking and reidentifying a 3D object on the basis of memory shown in FIG. 1.

### DETAILED DESCRIPTION OF EXEMPLARY EMBODIMENTS

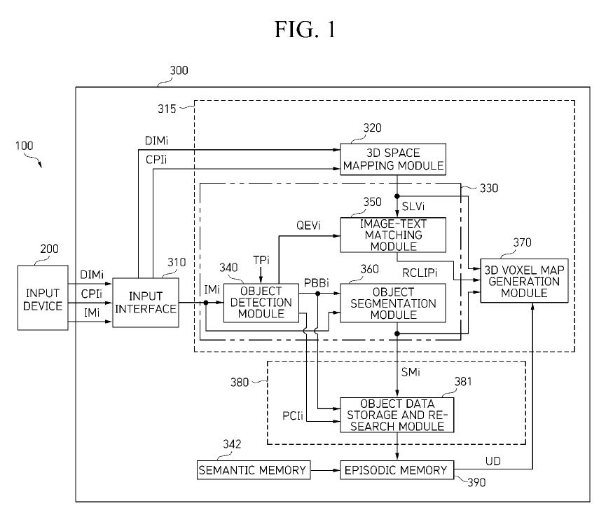

FIG. 1 is a block diagram of a three-dimensional (3D) space mapping system for tracking and reidentifying a 3D object on the basis of memory according to an embodiment of the present document.

Referring to FIG. 1, a 3D space mapping system 100 for tracking and reidentifying a 3D object on the basis of memory (hereinafter “system”) includes an input device 200 and a 3D space mapping device 300 for tracking and reidentifying a 3D object on the basis of memory (hereinafter “device”).

The system 100 may be a robot vision system, an augmented reality (AR) system, an autonomous driving system, a smart manufacturing system, a digital twin system, or an intelligent surveillance system.

A smart manufacturing system refers to a manufacturing system that integrates information and communication technology (ICT), Internet of things (IoT) sensors, automation technology, artificial intelligence (AI), big data, robotics, etc., throughout the entire manufacturing process to maximize productivity, enhance quality, and intelligently execute operations.

A digital twin system refers to a virtual model having the same characteristics as a real-world object (e.g., a product, equipment, a process, a city, etc.). A digital twin system connects physical and virtual worlds on the basis of data to monitor a state in real time and perform simulation, prediction, optimization, and control.

The system 100 may utilize deep learning models (e.g., a contrastive language-image pretraining (CLIP) model, an open-world localization with vision transformers (OWL-ViT, commonly classified as an object-aware vision-language model), and a segment anything model

(SAM)) to search for objects included in red-green-blue (RGB) images Imi on the basis of the RGB images Imi and depth images DIMi which are input in chronological order and store and manage found objects with 3D spatial location information.

Also, the system 100 may effectively detect the objects by fusing visual features of the objects included in the RGB images IMi and text information and store detected data in a semantic memory 342 and an episodic memory 390 to continuously track and re-recognize the objects.

The input device 200 includes a camera for generating the RGB images IMi and the depth images DIMi. The input device 200 may be a time-of-flight (ToF) camera, a stereo camera, or an RGB-depth (D) sensor but is not limited thereto.

The device 300 includes an input interface 310, a first-type processor 315, the semantic memory 342, a second-type processor 380, and the episodic memory 390.

The first-type processor 315 may be a graphics processing unit (GPU) for executing a deep learning model or an AI algorithm and may include hardware acceleration devices such as an application-specific integrated circuit (ASIC), a field programmable gate array (FPGA), neural processing unit (NPU), and the like.

The second-type processor 380 may be, but is not limited to, a central processing unit (CPU) and may include various processors for performing general computational function such as a microcontroller unit (MCU), a digital signal processor (DSP), and the like.

For convenience in the following description, the first-type processor 315 is referred to as “GPU,” and the second-type processor 380 is referred to as “CPU.”

Programs executed on the GPU 315 include a 3D space mapping module 320, an object detection module 340, an image-text matching module 350, an object segmentation module 360, and a 3D voxel map generation module 370.

The term “module” described in this specification refers to a functional or structural combination of program code, meaning a software unit configured to perform a specific computation or function. Accordingly, each module may be executed independently or may interact with other modules to perform specific functions of a system.

A processing module 330 including the object detection module 340, the image-text matching module 350, and the segmentation module 360 is associated with the semantic memory 342, and object representation information of each object generated by the processing module 330 is stored in the semantic memory 342. The object representation information is also referred to as “multimodal object information.”

The object representation information includes at least one of visual information, semantic information, and spatial information.

The visual information is information on at least one of the object’s appearance, shape, and features extracted directly from an RGB image or a depth image. For example, visual information may be information describing “what the object looks like.”

The semantic information may be information about what the object is, what category the object belongs to, and what semantic attributes the object has. For example, semantic information may be a class or label of the object, indicating whether the object is a table, an apple, or a cup.

The spatial information represents where the object exists and how the object is positioned in 3D space and may include the object’s position, depth, orientation, pose, 3D coordinates, bounding box, motion vector, etc., extracted from RGB images and depth images.

It is assumed that a program corresponding to the processing module 330 is executed on a higher-level processing system including the semantic memory 342 and the semantic memory 342 itself is not an element that performs computations but rather an element that stores and manages computational results.

A program executed on the CPU 380 includes an object data storage and re-search module 381.

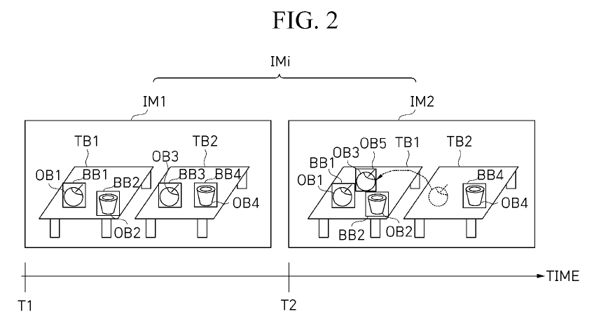

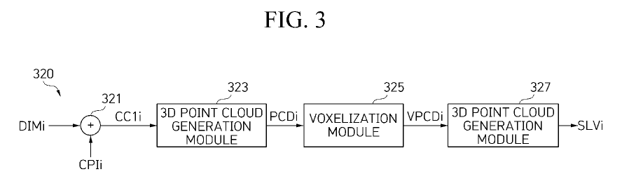

FIG. 2 is a set of RGB images input in chronological order, and FIG. 3 is a block diagram of a 3D space mapping module included in the 3D space mapping system for tracking and reidentifying a 3D object on the basis of memory shown in FIG. 1.

Referring to FIGS. 1 to 3, the input interface 310 receives a first RGB image IMi (i=1), a first depth image DIMi (i=1), and first camera pose information CPIi (i=1) from the input device 200 at a first time point T1 in a chronological order of T1 and T2.

First, an operation of the system 100 at the first time point T1 will be described below.

A first RGB image IM1 and first camera pose information CPI1 are transmitted to a 3D space mapping module 320, and the first RGB image IM1 is transmitted to the object detection module 340.

The 3D space mapping module 320 includes a concatenation module 321, a 3D point cloud generation module 323, a voxelization module 325, and a 3D spatial location vector generation module 327.

The 3D space mapping module 320 may analyze rotation information (e.g., yaw, pitch, and roll) of an object in 3D space using the first camera pose information CPI1 and correct position information of the object in the 3D space by performing alignment between the first RGB image IM1 and the first depth image FIM1 using the analysis results.

The concatenation module 321 receives the first depth image DIM1 and the first camera pose information CPI1, generates concatenation information CC11 by concatenating the two kinds of information DIM1 and CPI1, and outputs the concatenation information CC11 to the 3D point cloud generation module 323.

The 3D point cloud generation module 323 converts a depth value of each pixel included in the first depth image DIM1 into a 3D coordinate on the basis of the concatenation information CC11, generates a 3D point cloud PCD1 on the basis of the converted 3D coordinates, and outputs the 3D point cloud PCD1 to the voxelization module 325.

The voxelization module 325 generates a voxelized 3D point cloud VPCD1 by converting the 3D point cloud PCD1 into voxel units having a certain size and outputs the voxelized 3D point cloud VPCD1 to the 3D spatial location vector generation module 327.

The 3D spatial location vector generation module 327 generates a voxel map on the basis of the voxelized 3D point cloud VPCD1 and generates a 3D spatial location vector SLV1 by extracting a 3D location of a specific object in the form of a vector on the basis of the voxelized 3D point cloud VPCD1 and the voxel map. Therefore, the position and structure of the specific object can be precisely represented in the 3D space through the 3D spatial location vector SLV1.

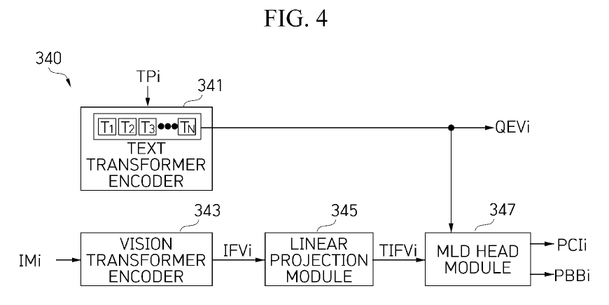

FIG. 4 is a block diagram of the object detection module included in the 3D space mapping system for tracking and reidentifying a 3D object on the basis of memory shown in FIG. 1.

Referring to FIGS. 1, 2, and 4, the object detection module 340 includes a text transformer encoder 341, a vision transformer encoder 343, a linear projection module 345, and a multi-layer perceptron head (MLP) head module 347.

The object detection module 340 for providing an object detection function may predict bounding box information and class information of objects TB1, OB1, OB2, TB2, OB3, and OB4 included in the first RGB image IM1 by utilizing an OWL-ViT-based vision-language model, thereby generating predicted bounding box information PBB1 and predicted class information PVI1. BB1 to BB4 shown in FIG. 2 are bounding boxes for the objects OB1, OB2, OB3, and OB4.

When a user tries to detect a specific object in the first RGB image IM1, a text prompt TP1 composed of the user’s text input or predefined ScanNet200 labels is provided as an input to the text transformer encoder 341.

The text transformer encoder 341 divides the text prompt TP1 into a plurality of tokens through a tokenizer, converts the text prompt TP1 into embedding vectors T1 to TN corresponding to the plurality of the plurality of tokens, and encodes the embedding vectors T1 to TN into a single query embedding vector QEV1 through a computation and contextualization process. In this way, a meaning of the text prompt is expressed as one vector, and the query embedding vector QEV1 may be referred to by the image-text matching module 350.

The vision transformer encoder 343 extracts an image feature vector IFV1 by performing a patch embedding and transformer-based visual feature extraction process on the first RGB image IM1 and transmits the image feature vector IFV1 to the linear projection module 345.

The linear projection module 345 generates a normalized linear transformation image feature vector TIFV1 in a representation format for object detection, by applying a learned linear transformation on the image feature vector IFV1 and transmits the linear transformation image feature vector TIFV1 to the MLP head module 347.

The MLP head module 347 calculates object class possibilities and bounding box regression values for each of the object candidates TB1, OB1, OB2, TB2, OB3, and OB4 included in the first RGB image IM1 on the basis of the linear transformation image feature vector TIFV1 and the query embedding vector QEV1 and outputs predicted bounding box information PBB1 including position information and size information of the object candidates TB1, OB1, OB2, TB2, OB3, and OB4 and predicted class information PCI1 indicating types of the object candidates TB1, OB1, OB2, TB2, OB3, and OB4 in accordance with calculation results.

The predicted bounding box information PBB1 is position information and size information including center coordinates (x, y), widths, and heights of bounding boxes for the objects candidates TB1, OB1, OB2, TB2, OB3, and OB4.

The predicted class information PCI1 indicates that the object candidates TB1 and TB2 are classified as tables, the objects OB1 and OB3 are classified as apples, and the objects OB2 and OB4 are classified as cups.

The image-text matching module 350 provides a function of detecting an object corresponding to a specific text query included in the text prompt TP1 in the first RGB image IM1 on the basis of results of object detection performed by the object detection module 340 using a CLIP-based contrastive language-image matching algorithm.

The image-text matching module 350 calculates a dot product of the 3D spatial location vector SLV1 corresponding to each 3D object included in the voxelized point cloud VPCD1 and the query embedding vector QEV1, evaluates the semantic correspondence, i.e., similarity, between each text query included in a text prompt 115 and each 3D object on the basis of the calculated dot product value, searches for the most suitable 3D object for each text query among 3D objects included in the voxelized point cloud VPCD1 on the basis of the evaluated similarity, and outputs a search result as a CLIP matching result RCLIP1.

Here, the CLIP matching result RCLIP1 is at least one most suitable 3D object that is selected in accordance with semantic correspondence information between each text query included in the text prompt TP1 and each 3D object included in the voxelized point cloud VPCD1.

For example, when a text query included in the text prompt TP1 input by the user is “apple,” the image-text matching module 350 may search for the 3D objects OB1 and OB3 that most closely match “apple” in the voxelized point cloud VPCD1 corresponding to the first RGB image IM1, and the search results are output as CLIP matching results RCLIP1.

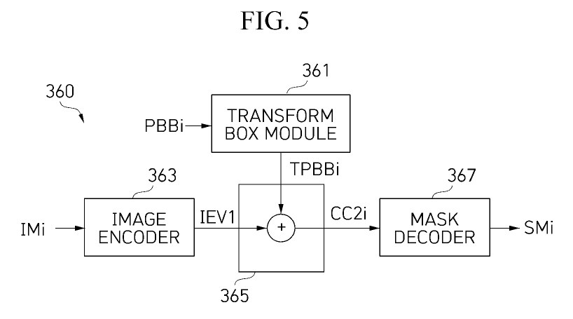

FIG. 5 is a block diagram of the object segmentation module included in the 3D space mapping system for tracking and reidentifying a 3D object on the basis of memory shown in FIG. 1.

Referring to FIGS. 1, 2, and 5, the SAM-based object segmentation module 360 is configured to divide detected objects more precisely using the predicted bounding box information PBB1 output from the OWL-ViT-based object detection module 340.

The object segmentation module includes a transform box module 361, an image encoder 363, a convolutional neural network (CNN) 365, and a mask decoder 367.

The transform box module 361 receives the predicted bounding box information PBB1 output from the object detection module 340, transforms a format and size of the predicted bounding box information PBB1 such that the predicted bounding box information PBB1 is processible by the CNN 365 and/or the mask decoder 367, and outputs transformed bounding box information TPBB1.

The image encoder 363 receives the first RGB image IM1 and extracts visual features, such as shapes, colors, textures, spatial structures, and inter-object correlations, of the objects TB1, OB1, OB2, TB2, OB3, and OB4 included in the first RGB image IM1.

The extracted visual features may be converted into an image embedding vector IEV1 represented as a vector, and then the image embedding vector IEV1 may be processed and utilized in the CNN 365.

The CNN 365 concatenates the transformed bounding box information TPBB1 output from the transform box module 361 and the image embedding vector IEV1 output from the image encoder 363 and generates a visual feature map CC21 reflecting boundaries and shapes of the objects TB1, OB1, OB2, TB2, OB3, and OB4 included in the first RGB image IM1 on the basis of concatenated features. The visual feature map CC21 is transmitted to the mask encoder 367, enabling the mask encoder 367 to generate a precise segmentation mask SM1.

The segmentation mask SM1 visually shows the accurate boundaries of the objects TB1, OB1, OB2, TB2, OB3, and OB4 existing in the first RGB image IM1. The segmentation mask SM1 provides segmentation results that closely adhere to actual boundaries of the objects TB1, OB1, OB2, TB2, OB3, and OB4 by reflecting the shapes of the objects TB1, OB1, OB2, TB2, OB3, and OB4 more precisely than the bounding boxes of the objects TB1, OB1, OB2, TB2, OB3, and OB4 detected by the object detection module 340.

In other words, the segmentation mask SM1 is a high-resolution segmentation mask that is generated by the object segmentation module 360 on the basis of the bounding box information PBB1 provided by the object detection module 340.

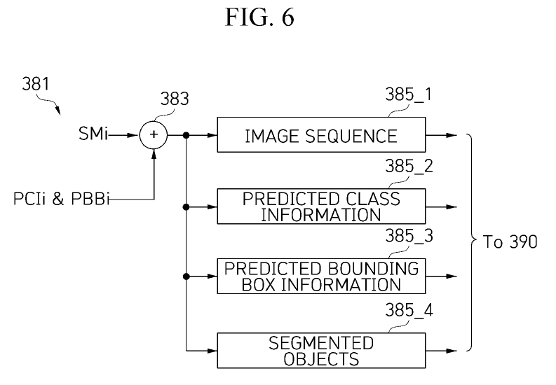

FIG. 6 is a block diagram of the object data storage and re-search module included in the 3D space mapping system for tracking and reidentifying a 3D object on the basis of memory shown in FIG. 1.

Referring to FIGS. 1, 2, and 6, the object data storage and re-search module 381 stores the segmentation mask SM1 output from the object segmentation module 360 in the episodic memory 390, enabling immediate handling of object re-recognition and situational changes in the future.

The object data storage and re-search module 381 includes a concatenation module 383, and the concatenation module 383 concatenates the segmentation mask SM1 output from the object segmentation module 360, the predicted bounding box information PBB1, and the predicted class information PCI1.

The concatenation module 383 generates an image sequence 385_1 including RGB images, the predicted class information 385_2 or PCI1, the predicted bounding box information 385_3 or PBB1, and the segmented object information 385_4 or SM1 on the basis of a concatenation result and stores the generated information in the episodic memory 390. In this way, object information is accumulated in a structured form and may effectively be utilized in a process of re-searching and re-recognizing an object and analyzing situational changes thereafter.

At the second time point T2 which is later than the first time point T1 in the chronological order of T1 and T2, the input interface 310 receives a second RGB image IMi (i=2), a second depth image DIMi (i=2), and second camera pose information CPIi (i=2) from the input device 200.

Except that a reference numeral i is 1 for the first time point T1 and 2 for the second time point T2, operations of the modules 320, 330, 370, and 381 processing the data CC11, PCD1, VPCD1, SLV1, QEV1, IFV1, TIFV1, PCI1, PBB1, IEV1, CC21, and SM1 on the basis of the first RGB image IM1, the first depth image DIM1, and the first camera pose information CPI1 of the first time point T1 are the same as operations of the modules 320, 330, 370, and 381 processing data CC12, PCD2, VPCD2, SLV2, QEV2, IFV2, TIFV2, PCI2, PBB2, IEV2, CC22, and SM2 on the basis of the second RGB image IM2, the second depth image DIM2, and the second camera pose information CPI2 of the second time point T2. Accordingly, detailed description thereof will be omitted.

The device 300 includes the semantic memory 342 and the episodic memory 390 to track movement and state changes of objects in accordance with environmental changes.

When information on new surroundings is input, the semantic memory 342 detects visual changes and spatial changes of new objects on the basis of open-vocabulary object detection and combines them with an existing environment to expand the existing environment to a new environment, and the added information on new surroundings is stored in the episodic memory 390.

Expansion includes an operation of adding at least one of a new feature, an attribute, a pose change, and a 3D location change to current object information and an operation of reconstructing the current object information into latest information by reflecting at least one of new visual information, semantic information, and spatial information into past object information.

The storage and re-search module 381 supports operations of the episodic memory 390 such that the episodic memory 390 may analyze whether the object OB3 moves and transmit analysis results UD to the 3D voxel map generation module 370 and the user may re-search for the object OB3 which is at a specific position at a specific time.

The 3D voxel map generation module 370 may perform an object relocalization operation by concatenating the analysis results UD output from the object data storage and re-search module 381, the voxel map output from the 3D space mapping module 320, and the CLIP matching result RCLIP1 output from the image-text matching module 350. The user who uses the system 100 can rapidly search for an object searched for in the past, (e.g., the moved object OB3) and the system 100 can implement a precise 3D object recognition and mapping function in various application environments such as autonomous driving, robot navigation, AR, and the like.

As described above with reference to FIGS. 1 to 6, the GPU 315 detects the objects TB1, OB1, OB2, TB2, OB3, and OB4 by combining pairs of the RGB images IM1 and IM2 and the depth images DIM1 and DIM2 input in a chronological order of T1 and T2, stores object representation information (e.g., information including at least one of visual information, semantic information, and spatial information) of the detected objects TB1, OB1, OB2, TB2, OB3, and OB4 in the semantic memory 342, and then moves the visual information and semantic information of the detected objects TB1, OB1, OB2, TB2, OB3, and OB4 stored in the semantic memory 342 to the episodic memory 390 in chronological order.

The GPU 315 compares and analyzes the past object information and the current object information read from the episodic memory 390 to analyze movement paths and location changes of the objects TB1, OB1, OB2, TB2, OB3, and OB4. The past object information is information related to the first RGB image IM1 and the first depth image DIM1 of the first time point T1, and the current object information is information related to the second RGB image IM2 and the second depth image DIM2 of the second time point T2. Obviously, the past object information may include the first camera pose information CPI1 of the first time point T1, and the current object information may include the second camera pose information CPI2 of the second time point T2.

The GPU 315 may generate a3D voxel map on the basis of the past object information, re-localize the 3D voxel map on the basis of the current object information, and update the 3D voxel map with the re-localized 3D voxel map.

A first episode stored in the episodic memory 390 is on the assumption that the first apple OB1 and the first cup OB2 are placed on the first table TB1 included in the first RGB image IM1 captured at the first time point T1 and the second apple OB3 and the second cup OB4 are placed on the second table TB2.

A second episode stored in the episodic memory 390 is on the assumption that the first apple OB1, the first cup OB2, and the second apple OB3 are placed on the first table TB1 and only the second cup OB4 is placed on the second table TB2 because the second apple OB3 on the second table TB2 included in the second RGB image IM2 captured at the second time point T2 is moved to the first table TB1.

Accordingly, the GPU 315 may re-search an object (e.g., OB3) included in the past object information on the basis of the past object information and the current object information stored in at least one of the semantic memory 342 and the episodic memory 390.

The GPU 315 may detect an object on the basis of open-vocabulary object detection.

When object information of a new object is included in current object information, the GPU 315 may expand the current object information by combining visual and spatial changes of the new object with past object information using semantic memory 342.

The GPU 315 detects an object corresponding to a text prompt TPi in the RGB images IM1 and IM2 on the basis of OWL-ViT, generates a query embedding vector QEVi corresponding to the text prompt TPi, and generates predicted class information PCIi and predicted bounding box information PBBi for the detected object.

OWL-ViT may include a zero-shot object detection function to detect a new object class not included in training data.

The GPU 315 may generate a 3D point cloud PCDi by combining the depth images DIMi and the pose information CPIi of the camera that generates the depth images DIMi, generates a voxelized 3D point cloud VPCDi by converting the 3D point cloud PCDi into voxel units having the certain size, generate a voxel map on the basis of the voxelized 3D point cloud VPCDi, and generate a 3D spatial location vector SLVi by extracting a 3D location of an object included in the voxelized 3D point cloud VPCDi in the form of a vector.

The GPU 315 may calculate a dot product of a3D spatial location vector SLVi corresponding to each 3D object included in the voxelized 3D point cloud VPCDi and the query embedding vector QEV1, evaluates similarity between each text query included in the text prompt TPi and each 3D object on the basis of the calculated dot product, searches for the most suitable 3D object for each text query among 3D objects included in the voxelized point cloud VPCDi on the basis of the evaluated similarity, and output a search result as a CLIP-based contrastive language-image matching result RCLIPi.

The GPU 315 may extract an object mask SMi using a pretrained segmentation model, for example, a SAM, on the basis of the predicted bounding box information PBBi and the RGB images IMi.

The CPU 380 may manage (e.g., store, retrieve, and output) the past object information and the current object information stored in the episodic memory 390.

A device according to the present document can search for an object by effectively combining existing image data (e.g., information on an object detected in the past) and new image data collected in real time using at least one of visual data, semantic data, and 3D space data.

Existing object detection and recognition technologies involve processing new data every moment, which leads to high computational costs and difficulties in maintaining consistency. However, a device according to the present document can compare past object information and current object information by utilizing a semantic memory and an episodic memory together and optimally perform object detection and object recognition in accordance with comparison results, leading to an improvement in object recognition accuracy. Also, computational resources can be saved, resulting in smoother real-time detection.

Unlike in existing 2D image-based object search, a device according to the present document can spatially search for an object and track the position of the object by utilizing a 3D voxel map.

Existing 2D-based object recognition technologies have limitations in accurately reflecting depth information, hindering recognition of object positions, and exhibit poor adaptability to changes in the surroundings.

However, a device according to the present document can analyze position information of an object more precisely through an object detection module and an object segmentation module and interoperate with a 3D space mapping module to continuously track how an object is placed in a specific environment. Since the device according to the present document can record and track the placement, movement, and changes of an object within 3D space in real time, the device can be useful in application sectors such as indoor navigation, robot vision, AR, and the like.

A device according to the present document does not simply search for object data but stores semantic data of objects in memory, enabling an immediate re-search when necessary.

Existing object detection systems have inability to immediately utilize detected objects and effectively store and utilize previously found data.

However, a device according to the present document stores object-specific features in memory through an object data storage and re-search module and thereafter loads the object features from the memory immediately when it is necessary to detect or reuse the same object, maximizing search performance. Therefore, the device according to the present document can reduce computational costs by preventing redundant searches, and data utilization can be improved by systematically managing object features and locations, map information, and the like.

Although the present document has been described with reference to embodiments shown in the drawings, the embodiments are merely illustrative, and those of ordinary skill in the art will understand that various modifications and equivalent other embodiments can be made from the embodiments. Therefore, the technical scope of the present document should be determined by the technical concept of the claims.

What is claimed is:

1. A three-dimensional (3D) space mapping device for tracking and reidentifying a 3D object based on memory comprising:
a semantic memory;
an episodic memory; and
a graphics processing unit (GPU) connected to the semantic memory and the episodic memory,
wherein the GPU detects an object by combining pairs of red-green-blue (RGB) and depth images which are input in chronological order,
stores object representation information of the detected object in the semantic memory and then moves the object representation information stored in the semantic memory to the episodic memory in the chronological order, and
compares and analyzes past object information and current object information read from the episodic memory to analyze a movement path and a location change of the object,
wherein the object representation information includes at least one of visual information, semantic information, and spatial information,
the past object information is information related to a first RGB image and a first depth image of a first time point, and
the current object information is information related to a second RGB image and a second depth image of a second time point.

2. The 3D space mapping device of claim 1, wherein the GPU generates a 3D voxel map on the basis of the past object information,
re-localizes the 3D voxel map on the basis of the current object information, and
updates the 3D voxel map with the re-localized 3D voxel map.

3. The 3D space mapping device of claim 1, wherein the GPU re-searches for the object included in the past object information on the basis of the past object information and the current object information stored in at least one of the semantic memory and the episodic memory.

4. The 3D space mapping device of claim 1, wherein the GPU detects the object on the basis of open-vocabulary object detection.

5. The 3D space mapping device of claim 1, wherein, when object information of a new object is included in the current object information, the GPU combines a visual change and a spatial change of the new object with the past object information using the semantic memory to expand the current object information.

6. The 3D space mapping device of claim 1, wherein the GPU detects the object corresponding to a text prompt in the RGB images on the basis of open-world localization with vision transformers (OWL-ViT),
generates a query embedding vector corresponding to the text prompt, and
generates predicted class information and predicted bounding box information for the detected object.

7. The 3D space mapping device of claim 6, wherein the OWL-ViT includes a zero-shot object detection function to detect a new object class not included in training data.

8. The 3D space mapping device of claim 6, wherein the GPU generates a 3D point cloud by combining the depth images and pose information of a camera that generates the depth images,
generates a voxelized 3D point cloud by converting the 3D point cloud into voxel units having a certain size,
generates a voxel map on the basis of the voxelized 3D point cloud, and
generates a 3D spatial location vector by extracting a 3D location of the object in a vector form.

9. The 3D space mapping device of claim 8, wherein the GPU calculates a dot product of a 3D spatial location vector corresponding to each 3D object included in the voxelized 3D point cloud and the query embedding vector,
evaluates similarity between each text query included in the text prompt and each 3D object on the basis of the calculated dot product,
searches for a most suitable 3D object for each text query among 3D objects included in the voxelized point cloud on the basis of the evaluated similarity, and
outputs a search result as a contrastive language-image pretraining (CLIP)-based contrastive language-image matching result.

10. The 3D space mapping device of claim 6, wherein the GPU extracts an object mask on the basis of the predicted bounding box information and the RGB images using a pretrained segmentation model.

11. The 3D space mapping device of claim 1, further comprising a central processing unit (CPU) configured to manage the past object information and the current object information stored in the episodic memory.

12. A three-dimensional (3D) space mapping system for tracking and reidentifying a 3D object based on memory, comprising:
an input device; and
a 3D space mapping device for tracking and re-identifying a 3D object on the basis of memory, connected to the input device,
wherein the 3D space mapping device comprises:
an input interface configured to receive pairs of red-green-blue (RGB) and depth images which are input in chronological order;
a semantic memory;
an episodic memory; and
a graphics processing unit (GPU) connected to the semantic memory, the episodic memory, and the input interface,
wherein the GPU detects an object by combining pairs of RGB and depth images received through the input interface in chronological order,
stores object representation information of the detected object in the semantic memory and then moves the object representation information stored in the semantic memory to the episodic memory in the chronological order, and
compares and analyzes past object information and current object information read from the episodic memory to analyze a movement path and a location change of the object,
wherein the object representation information includes at least one of visual information, semantic information, and spatial information,
the past object information is information related to a first RGB image and a first depth image of a first time point, and
the current object information is information related to a second RGB image and a second depth image of a second time point.

13. The 3D space mapping system of claim 12, wherein the GPU generates a 3D voxel map on the basis of the past object information,
re-localizes the 3D voxel map on the basis of the current object information, and
updates the 3D voxel map with the re-localized 3D voxel map.

14. The 3D space mapping system of claim 12, wherein the GPU re-searches for the object included in the past object information on the basis of the past object information and the current object information stored in at least one of the semantic memory and the episodic memory.

15. The 3D space mapping system of claim 12, wherein, when object information of a new object is included in the current object information, the GPU combines a visual change and a spatial change of the new object with the past object information using the semantic memory to expand the current object information.

16. The 3D space mapping system of claim 12, further comprising a central processing unit (CPU) configured to manage the past object information and the current object information stored in the episodic memory.

17. The 3D space mapping system of claim 12, wherein the 3D space mapping system is a robot vision system, an augmented reality (AR) system, an autonomous driving system, a smart manufacturing system, a digital twin system, or an intelligent surveillance system.

18. An operating method of a three-dimensional (3D) space mapping system for tracking and reidentifying a 3D object based on memory, operating method comprising:
detecting an object by combining pairs of red-green-blue (RGB) and depth images which are input in chronological order;
storing object representation information of the detected object in a semantic memory and then moving the object representation information stored in the semantic memory to an episodic memory in the chronological order; and
comparing and analyzing past object information and current object information read from the episodic memory to analyze a movement path and a location change of the object,
wherein the object representation information includes at least one of visual information, semantic information, and spatial information,
the past object information is information related to a first RGB image and a first depth image of a first time point, and
the current object information is information related to a second RGB image and a second depth image of a second time point.

19. The operating method of claim 18, further comprising:
generating a 3D voxel map on the basis of the past object information;
re-localizing the 3D voxel map on the basis of the current object information, and
updating the 3D voxel map with the re-localized 3D voxel map.

20. The operating method of claim 18, further comprising re-searching for the object included in the past object information on the basis of the past object information and the current object information stored in at least one of the semantic memory and the episodic memory.
